(19) United States
(12) Patent Application Publication
(10) Pub. No.: US 2026/0342084 A1
(43) Pub. Date: Oct. 29, 2026

(54) POWER PREDICTION DEVICE OF MICROGRIDS AND METHOD THEREOF

(71) Applicant: DELTA ELECTRONICS, INC., Taoyuan City (TW)

(72) Inventors: Zhe-Hao CHANG, Taoyuan City (TW); Yi-Kuan KE, Taoyuan City (TW)

(21) Appl. No.: 19/260,301

(22) Filed: Jul. 4, 2025

(30) Foreign Application Priority Data
Apr. 24, 2025 (TW) 114115592

(51) Int. Cl. H02J 3/00; G05B 13/02; H02J 13/12; H02J 103/30

(52) U.S. Cl. CPC H02J 3/004; G05B 13/0265; H02J 13/12; H02J 2103/30

(57) ABSTRACT

A power prediction method includes steps of: inputting sequential time-power data of a microgrid cluster into a microgrid cluster power-computing model to compute predicted time-power data; computing a monitoring indicator of the microgrid cluster power-computing model based on the predicted time-power data; adjusting a learning rate of the microgrid cluster power-computing model when determining that a stagnant condition is met based on the monitoring indicator, and consecutively inputting sequential time-power data into the microgrid cluster power-computing model to obtain the monitoring indicator; and obtaining a trained microgrid cluster power-computing model when the stagnant condition is not met and an execution count of the microgrid cluster power-computing model reaches a predefined epoch count, and using the trained microgrid cluster power-computing model to perform power prediction of multiple microgrids over a future time interval.

### CROSS-REFERENCE TO RELATED APPLICATION

This application claims priority to and the benefit of Taiwan Application Serial Number 114115592 filed on Apr. 24, 2025, the entire content of which is incorporated herein by reference as if fully set forth below in its entirety and for all applicable purposes.

### BACKGROUND

### Field of Disclosure

The disclosure generally relates to a power prediction device and a power prediction method, and more particularly to a power prediction device of microgrid and a power prediction method of microgrid.

### Description of Related Art

Microgrids being used as a distributed power system can be connected to the main power network to supply electricity. In the event of a power outage in the main power network, the microgrid can switch to an independent operating mode to provide power to regional areas. With the flexible resource scheduling capabilities of the microgrids, monitoring the operation status of the regional microgrids is an important aspect of the resource scheduling.

### SUMMARY

The disclosure can be more fully understood by reading the following detailed description of the embodiments, with reference made to the accompanying drawings as described below. It should be noted that the features in the drawings are not necessarily to scale. In fact, the dimensions of the features may be arbitrarily increased or decreased for clarity of discussion.

The present disclosure of an embodiment provides a power prediction method of microgrids performed by a computation device. The power prediction method includes steps of: inputting a time-series power data of the microgrids into a microgrid cluster power-computing model to compute a predicted time-power data; computing a monitoring indicator of the microgrid cluster power-computing model based on the predicted time-power data; adjusting a learning rate of the microgrid cluster power-computing model when determining a stagnant condition is met based on the monitoring indicator, and continuously inputting the time-series power data into the microgrid cluster power-computing model to obtain the monitoring indicator; and obtaining a trained microgrid cluster power-computing model when the stagnant condition is not met and an execution count reaches a predefined epoch count, and using the trained microgrid cluster power-computing model to perform a power prediction of the multiple microgrids over a future time interval.

The present disclosure of another embodiment provides a power prediction device of microgrids including a storage and a processor. The storage is configured to store multiple program codes and a microgrid cluster power-computing model. The processor is connected to the storage and configured to execute the multiple program codes to perform operations of: inputting a time-series power data of the microgrids into the microgrid cluster power-computing model to compute a predicted time-power data; computing a monitoring indicator of the microgrid cluster power-computing model based on the predicted time-power data; adjusting a learning rate of the microgrid cluster power-computing model when determining a stagnant condition is met based on the monitoring indicator, and continuously inputting the time-series power data into the microgrid cluster power-computing model to obtain the monitoring indicator; and obtaining a trained microgrid cluster power-computing model when the stagnant condition is not met and an execution count reaches a predefined epoch count, and using the trained microgrid cluster power-computing model to perform a power prediction of the multiple microgrids over a future time interval.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as described below. It should be noted that the features in the drawings are not necessarily to scale. In fact, the dimensions of the features may be arbitrarily increased or decreased for clarity of discussion.

FIG. 1 is a block diagram illustrating a power prediction device according to an embodiment of the disclosure.

FIG. 2 is a flowchart of a power prediction method according to an embodiment of the disclosure.

FIG. 3 is a diagram illustrating a model structure of the microgrid cluster power-computing model according to an embodiment of the disclosure.

FIG. 4 is a flowchart of the model computation of the microgrid cluster power-computing model according to an embodiment of the disclosure.

FIG. 5 is a diagram illustrating a prediction power curve and an actual power curve according to an embodiment of the disclosure.

### DETAILED DESCRIPTION

The specification provides various embodiments to facilitate the implementation of different features of the disclosure. The following descriptions of components and arrangements are illustrated as some aspects of implementations of the disclosure to prevent replication. It should be noted that the embodiments are exemplary and should not be limited herein. For example, technical terms such as ‘’first” and “second” used herein to describe components are merely for distinguishing among the similar to identical elements or operations. The terminology is not intended to limit the technical features of the disclosure, nor to indicate any particular order or priority of operations or steps.

The element symbols or alphabets can be used repeatedly in each embodiment of the disclosure, though, the repeated symbols and alphabets are provided for simplicity and clarity, and they should not be interpreted to limit the relation of the technical terms, nor the order of operations among the embodiments.

The components of the disclosure are described as being “connected”, “coupled”, or “linked”, such terms may refer to electrical connections, electrical coupling, or communicative links. The terms “connected”, “coupled”, or “linked” may also interpret cooperative operations or interactions between or among components.

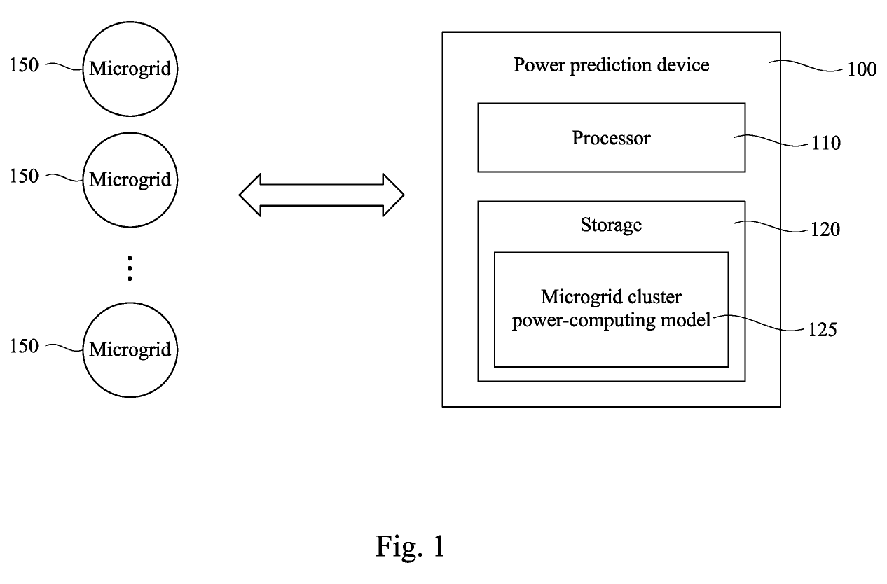

FIG. 1 is a block diagram illustrating a power prediction device according to an embodiment of the disclosure.

In one embodiment, the power prediction device 100 may obtain multiple time-power data of each microgrid 150 of the microgrid cluster (or called multiple microgrids 150) through interfaces and/or protocols, such as Supervisory Control and Data Acquisition (SCADA) or industrial protocols utilized in practical fields.

As shown in FIG. 1, the power prediction device 100 includes a processor 110 and a storage 120. The processor 110 is connected to the storage 120.

The power prediction device 100 may obtain the historical time-power data, the historical power data at every time point, of each microgrid 150. Because the power prediction device 100 performs predictions on the microgrids as a whole, the processor 110 combines the multiple historical time-power data from the multiple microgrids 150 to obtain time-series power data.

The historical time-power data is two-dimensional data including the time information and the electricity information. The processor 110 compiles the two-dimensional data of the multiple microgrids 150 to obtain an electricity dataset with high temporal granularity. For example, each microgrid 150 maintains its own time-power curve, and the processor 110 combines the time-power curves from all the microgrids 150 based on the time series to obtain a curve with high temporal granularity.

The storage 120 is configured to store multiple program codes and a microgrid cluster power-computing model 125. The processor 110 is configured to execute the program codes and deploy the microgrid cluster power-computing model 125.

In one embodiment, the time-series power data are the input data of the microgrid cluster power-computing model 125, and the power prediction device 100 performs the power prediction on the microgrid cluster to compute the predicted time-power data of the microgrid cluster.

In one embodiment, the power prediction device 100 utilizes the historical time-power data of the multiple microgrids 150 to train the microgrid cluster power-computing model 125. After the power prediction device 100 obtains the microgrid cluster power-computing model 125 trained by the historical time-power data, the power prediction device 100 inputs the historical time-power data (may be different year, date, timeslot, etc.) to the microgrid cluster power-computing model 125 to predict the time-power data of the future time interval temporally aligned with the past time interval. For example, a training dataset includes the historical time-power data collected over a 30-day period, with each batch including 24 data (i.e., each data representing one hour, and one batch including 24 data corresponding 24 hours a day). The microgrid cluster power-computing model 125 may utilize the 30-day historical time-power data to predict the power data of the 24 hours following the past time.

In the training operations of the microgrid cluster power-computing model 125, the power prediction device 100 treats the time-series power data as the training dataset, and the dataset is split into multiple batches so the multiple batches may be utilized for training at each epoch. After the microgrid cluster power-computing model 125 performs training at each epoch, the microgrid cluster power-computing model 125 outputs the predicted time-power data and consecutively performs training of the model computation at the next epoch. Suppose that the batch size is M and the size of the input dataset is N, the microgrid cluster power-computing model 125 performs N/M times (N is divided by M) iterations. After all the iterations are completed, one epoch of training is finished.

In one embodiment, the power prediction device 100 utilizes the predicted time-power data to compute a monitoring indicator of the microgrid cluster power-computing model 125. The monitoring indicator may be the loss rate or the accuracy. The power prediction device 100 computes the loss function to obtain the loss rate or computes the difference between the time-series power data and the predicted time-power data to obtain the accuracy. For example, when the difference, between the time-series power data and the predicted time-power data, lies within a tolerance range, it indicates one correct prediction. The accuracy may be the ratio between the sample quantity correctly predicted and the total sample quantity.

It should be noted that the processor 110 computes one loss rate or the accuracy at every epoch of training and determines how to adjust the model parameters according to the current condition of the model.

The power prediction device 100 utilizes the monitoring indicator to estimate the training quality of the microgrid cluster power-computing model 125. In one embodiment, the processor 110 determines whether the stagnant condition is met. The stagnant condition indicates that the loss rate does not continuously decrease or the accuracy does not continuously increase achieving a first quantity of the epochs during training, to estimate the model quality.

The loss rate is applied to measure a prediction quality of the microgrid cluster power-computing model 125. Therefore, the processor 110 estimates the variation of the loss rates during the consecutive epochs of training. In one embodiment, the processor 110 determines whether the loss rates show trends of continuously decreasing. The term “continuously decreasing” indicates that the variation of the loss rates of the consecutive epoch of training is decreasing.

The accuracy is another measurement for the prediction quality of the microgrid cluster power-computing model 125. The processor 110 estimates the variation of the accuracy during the consecutive epochs of training. In one embodiment, the processor 110 determines whether the accuracy shows trends that are not continuously increasing. The term “continuously increasing” indicates that the variation of the accuracy of the consecutive epoch of training is increasing.

In the circumstances that the processor 110 determines the stagnant condition is not met, it indicates that the loss rates continuously decrease or the accuracy continuously increases or does not plateau. At this time, the processor 110 keeps the next epoch of the model computation. In the circumstances that the processor 110 determines the stagnant condition is met, it indicates that the efficiency of the model training decreases or plateaus. At this time, the processor 110 adjusts a learning rate for the microgrid cluster power-computing model 125. The learning rate is applied to modify hyperparameters of the microgrid cluster power-computing model 125 to adjust the result of the next epoch of the model computation.

In one embodiment, in the case that the stagnant condition is met, the learning rate is modified to be reduced.

The processor 110 keeps performing the model computation until a predefined epoch count (the maximum number of epochs) is reached. At this time, the microgrid cluster power-computing model 125 trained (the trained microgrid cluster power-computing model) is obtained.

On the other hand, when the processor 110 determines whether the stagnant condition is met, the processor 110 also determines whether an early stopping condition is met. The early stopping condition indicates that the loss rate does not continuously decrease or the accuracy does not continuously increase achieving a second quantity of the epochs during training, to estimate the model quality. The second quantity is greater than the first quantity. When the early stopping condition is met, it indicates that the model training shows no further progress. At this time, further training is unlikely to enhance the model performance. Therefore, the processor 110 completes (stopping) the training of the microgrid cluster power-computing model 125 in advance, so the microgrid cluster power-computing model 125 has the best condition during the training stage.

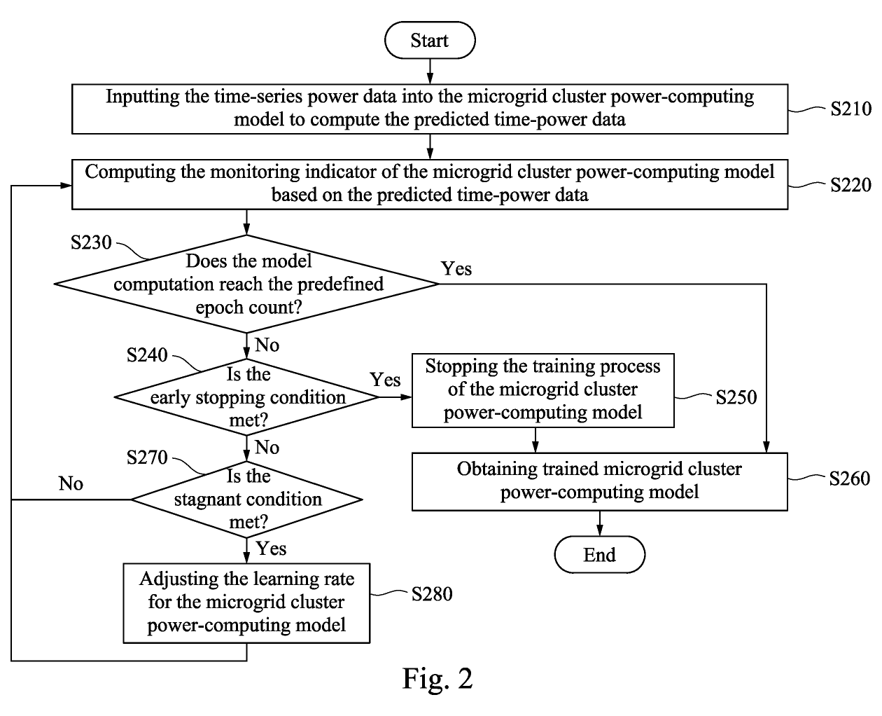

For the sake of understanding the specification, reference is made to FIG. 1 and FIG. 2. FIG. 2 is a flowchart of a power prediction method according to an embodiment of the disclosure. The power prediction method of FIG. 2 may be implemented by a computation device. The computation may be an electronic device disposed one or more processors and storage(s). In one embodiment, the computation device may be the computation device 100 of FIG. 1.

In step S210, inputting the time-series power data into the microgrid cluster power-computing model 125 to compute the predicted time-power data is performed.

In one embodiment, the processor 110 combines the multiple historical time-power data from the multiple microgrids 150 to obtain the time-series power data.

In step S220, computing the monitoring indicator of the microgrid cluster power-computing model 125 based on the predicted time-power data is performed.

The monitoring indicator may be the loss rate or the accuracy. For example, the power prediction device 100 computes the loss function to obtain the loss rate or computes the difference between the time-series power data and the predicted time-power data to obtain the accuracy.

In step S230, the processor 110 determines whether the model computation reaches the predefined epoch count.

The processor 110 computes the loss rate or the accuracy one time at every epoch.

If the predefined epoch count is not reached, the process proceeds to step S240; if the predefined epoch count is reached (step S230), the process proceeds to step S260.

The predefined epoch count may be the maximum of the epochs performed by the model, as a termination condition of the model computation. Generally, the process keeps going through the model computation as the predefined epoch count is not reached.

In step S240, the processor 110 determines whether the early stopping condition is met. The early stopping condition indicates that the loss rate does not continuously decrease or the accuracy does not continuously increase achieving the second quantity of the epochs during training. For example, suppose that the second quantity is 15 times and the predefined epoch count is 1000 times. The loss rates show plateauing or fluctuating trend during the 850-th to the 865-th epoch of the model computations, where the 865-th time does not achieve the 1000-th time of the predefined epoch count yet. At this time, the processor 110 determines that the early stopping condition is met and performs step S250, completing (stopping) the training process of the microgrid cluster power-computing model 125 in advance, and the trained microgrid cluster power-computing model is obtained in step S260.

On the other hand, if the early stopping condition is not met (step S240), the process proceeds to step S270.

In step S270, determining whether the stagnant condition is met is performed. If the stagnant condition is met, the process proceeds to step S280. If the stagnant is not met, the process goes back to step S220.

The stagnant condition indicates that the loss rate does not continuously decrease or the accuracy does not continuously increase achieving the first quantity of consecutive epochs during training, where the second quantity is greater than the first quantity, and the first quantity and the second quantity are less than the predefined epoch count. For example, suppose that the first quantity is 5 times and the model performs to the 100-th epoch of the model computation. If the loss rates or the accuracy show plateauing or fluctuating trend during the 96-th epoch to the 100-th epoch of the model computations, the processor 110 determines that the early stopping condition is not met (step S240) but the stagnant condition is met (step S270). In other words, if the loss rates do not continuously decrease, the accuracy does not continuously increase, or both the monitoring indicators plateau, it indicates that the microgrid cluster power-computing model 125 enters the stagnant state.

In step S270, when the processor 110 determines that the microgrid cluster power-computing model 125 enters the stagnant state, the learning rate for the microgrid cluster power-computing model 125 is adjusted in step S280.

If the microgrid cluster power-computing model 125 performs the model computation achieving the predefined epoch count (step S230) and both the stagnant condition and the early stopping condition are not met, it indicates that the training process is stable and effective. At this time, the process proceeds to step S260, the trained microgrid cluster power-computing model 125 is obtained. In one embodiment, the trained microgrid cluster power-computing model 125 may perform the power prediction of the multiple microgrids 150 over a future time interval.

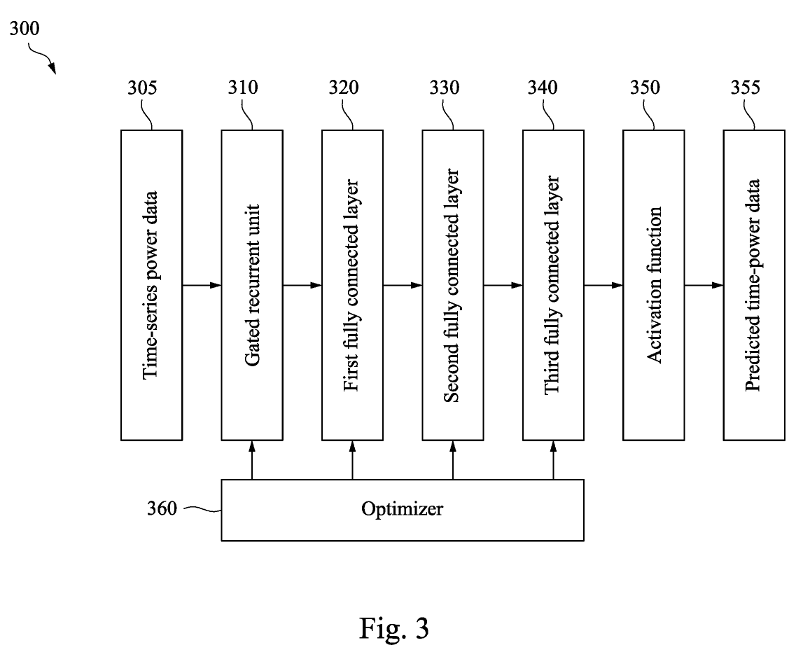

FIG. 3 is a diagram illustrating a model structure of the microgrid cluster power-computing model according to an embodiment of the disclosure. The microgrid cluster power-computing model 300 of FIG. 3 is the detailed model structure of the microgrid cluster power-computing model 125 of FIG. 1.

In one embodiment, the microgrid cluster power-computing model 300 includes a gated recurrent unit 310, a first fully connected layer 320, a second fully connected layer 330, a third fully connected layer 340, an activation function 350, and an optimizer 360.

The gated recurrent unit 310, the first fully connected layer 320, the second fully connected layer 330, and the third fully connected layer 340 may use the structure of the artificial neural network and be utilized as one layer of the microgrid cluster power-computing model 300, where each layer includes multiple nodes and each node performs computations on the input data and outputs results to next layer.

In one embodiment, the gated recurrent unit 310, being the input layer of the microgrid cluster power-computing model 300, receives the time-series power data 305 combining the multiple historical time-power data.

The gated recurrent unit 310 may be the neural network designed based on the Recurrent Neural Network (RNN), including at least a reset gate, an update gate, and a candidate hidden state.

The operations of the gated recurrent unit 310 include: the reset gate computes the weights of the time-series power data 305 with respect to time, the reset gate decides which historical electricity data to eliminate, and the candidate hidden state updates the hidden state of the current time.

In one embodiment, the gated recurrent unit 310 receives the time-series power data 305, performs information retention, deletion, or updating, computes multiple temporal state features, and preserves the features having correlated states among the time-series. Since the gated recurrent unit 310 may determine which historical information to retain and memorize long-term time-series relation, the gated recurrent unit 310 may efficiently process the time-series data while mitigating the issue of long-term dependencies.

The first fully connected layer 320, the second fully connected layer 330, and the third fully connected layer 340 are fully connected layers. That is, every node (neuron) of the former layer fully connects with every node of the current layer.

In one embodiment, every node of the first fully connected layer 320 receives all the hidden state outputted by the gated recurrent unit 310, and the output value of every node of the first fully connected layer 320 is respectively sent to every node of the second fully connected layer 330. Similarly, the output value of every node of the second fully connected layer 330 is respectively sent to every node of the third fully connected layer 340.

In one embodiment, the first fully connected layer 320 receives multiple temporal state features and performs the model computation to obtain multiple first advanced temporal features. The first fully connected layer 320 is used to transform and compress the multiple temporal state features to perform feature extraction in a first stage.

In one embodiment, the second fully connected layer 330 receives the multiple first advanced temporal features and performs the model computation to obtain multiple second advanced temporal features to perform feature extractions in a second stage.

The first fully connected layer 320 and the second fully connected layer 330 are utilized to perform the feature extractions, preserving important features to increase the hidden state of the high-level features.

The third fully connected layer 340 receives the multiple second advanced temporal features and performs regression computation to obtain multiple key temporal features. The multiple key temporal features output by the third fully connected layer 340 are sent to the activation function 350. The third fully connected layer 340 is mainly designed to perform regression computation to output the prediction value in time series.

The activation function 350 is configured to perform a non-linear transformation on multiple key temporal features to compute a predicted time-power data 355. By the non-linear transformation, the predicted time-power data 355 (related to the key temporal feature computed by the third fully connected layer 340) is a more accurate prediction.

In one embodiment, a node quantity of the first fully connected layer 320 is greater than a node quantity of the second fully connected layer 330, and the node quantity of the second fully connected layer 330 is greater than a node quantity of the third fully connected layer 340. For example, the node quantity of the first fully connected layer 320 is 256, the node quantity of the second fully connected layer 330 is 128, and the node quantity of the third fully connected layer 340 is 64.

In one embodiment, after multiple key temporal features are processed by the third fully connected layer 340, a data dimension of the output data of the third fully connected layer 340 is modified to be the same as a data dimension of the time-series power data 305. Subsequently, the activation function 350 performs the non-linear transformation on the output data whose data dimension is modified to fit the difference between the prediction and the actual time-power data.

After computing the multiple key temporal features, the microgrid cluster power-computing model 300 computes the difference between the predicted time-power data 355 and the time-series power data 305 according to an error indicator to obtain a prediction error. The smaller the prediction error value, the closer the prediction is to the actual value, indicating higher prediction accuracy.

In one embodiment, the optimizer 360 is configured to adjust a parameter update magnitude of each of the gated recurrent unit 310, the first fully connected layer 320, the second fully connected layer 330, and the third fully connected layer 340.

The optimizer 360 may be the optimizer of the Layer-wise Adaptive Moments optimizer for Batching training (LAMB). The optimizer 360 performs the weight regularization and adaptively updates the weights of each layer with layer-specific characteristics based on the vector norms of parameters in each layer (e.g., the L2 norm corresponding to the Euclidean magnitude of the parameter vector). For example, the optimizer 360 computes a first-order momentum and a second-order momentum and determines an update ratio of the weights of each layer according to the second-order momentum and the L2 norm of parameters in each layer. The update ratio is multiplied by a global learning rate to obtain a final update magnitude, being used to adjust the weights of parameters of each layer. Therefore, the gated recurrent unit 310, the first fully connected layer 320, the update speed of the second fully connected layer 330, and the third fully connected layer 340 may be respectively maintained at the suitable magnitude, preventing the gradient explosion or the gradient vanishing. Benefiting from the advantages above, the mode convergence is improved and the prediction accuracy is enhanced.

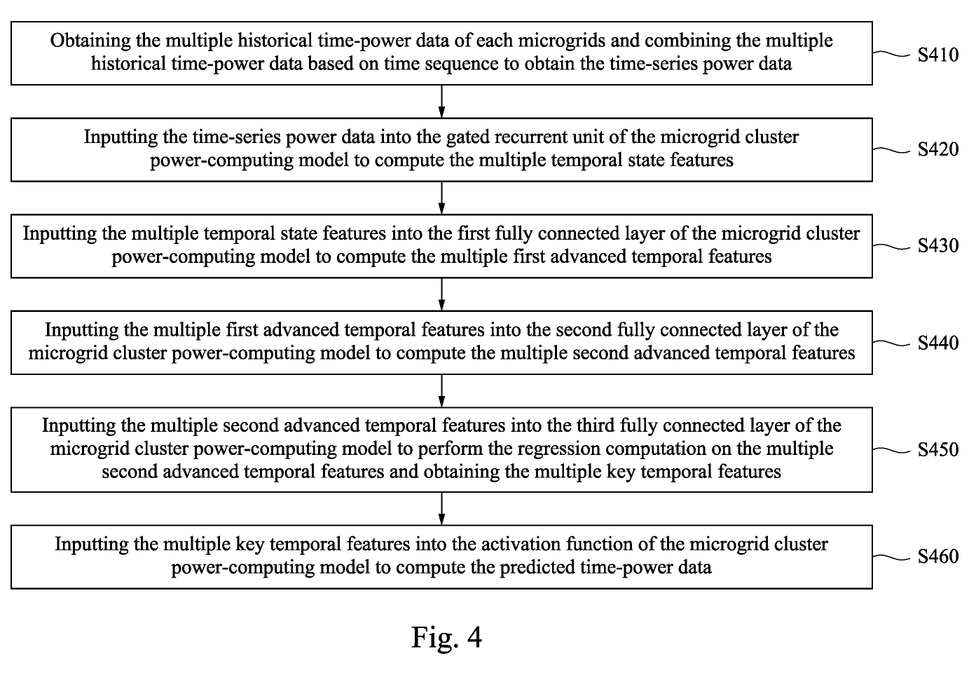

FIG. 4 is a flowchart of the model computation of the microgrid cluster power-computing model according to an embodiment of the disclosure. The model computation of FIG. 4 may be performed by a computation device. The computation may be an electronic device disposed one or more processors and storage(s). In one embodiment, the computation device may be the computation device 100 of FIG. 1.

In one embodiment, step S210 of FIG. 2 includes steps S420 to S460.

In step S410, obtaining the multiple historical time-power data of each microgrids and combining the multiple historical time-power data based on time sequence to obtain the time-series power data 305 is performed.

In step S420, inputting the time-series power data 305 into the gated recurrent unit 310 of the microgrid cluster power-computing model 300 to compute the multiple temporal state features is performed.

In step S430, inputting the multiple temporal state features into the first fully connected layer 320 of the microgrid cluster power-computing model 300 to compute the multiple first advanced temporal features is performed.

In step S440, inputting the multiple first advanced temporal features into the second fully connected layer 330 of the microgrid cluster power-computing model 300 to compute the multiple second advanced temporal features is performed.

In step S450, inputting the multiple second advanced temporal features into the third fully connected layer 340 of the microgrid cluster power-computing model 300 to perform the regression computation on the multiple second advanced temporal features and obtaining the multiple key temporal features is performed.

In step S460, inputting the multiple key temporal features into the activation function of the microgrid cluster power-computing model 300 to compute the predicted time-power data 355 is performed.

In one embodiment, the predicted time-power data 355 may be the prediction of power generation and electrical load. For example, when the historical time-power data refers to the past power generation data of the microgrids, the predicted time-power data 355 corresponds to the predicted power generation data; when the historical time-power data refers to the past electrical load of the microgrids, the predicted time-power data 355 corresponds to the predicted electrical load data.

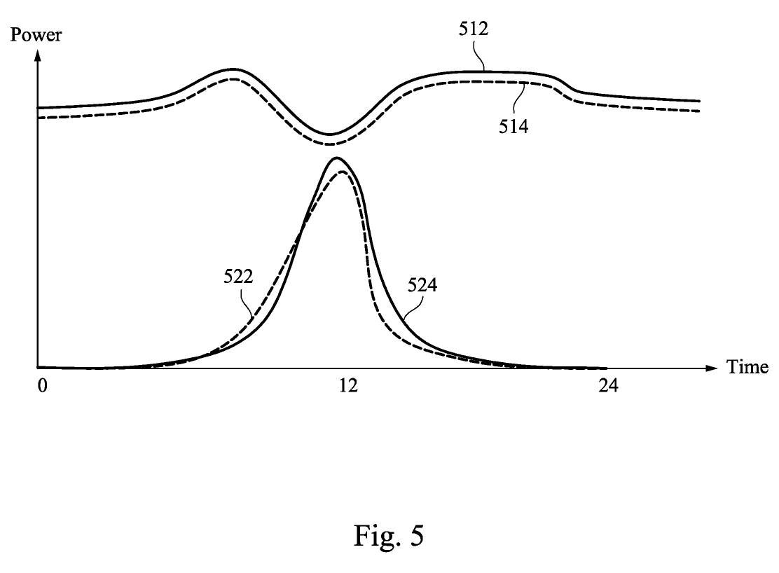

FIG. 5 is a diagram illustrating a prediction power curve and an actual power curve according to an embodiment of the disclosure.

In one embodiment, the power prediction device 100 predicts the power data for a future time interval based on the historical time-power data within a past time interval.

The following embodiment takes the power generation as an example. The power prediction device 100 uses the historical power generation data within the past time interval from 00:00 to 24:00 on Jan. 1, 2024 to compute the predicted power generation data from 00:00 to 24:00 on Jan. 2, 2024. As shown in FIG. 5, the power prediction device 100 uses the historical power generation data and obtains the predicted power generation data, as shown in curve 522. Furthermore, the power prediction device 100 subsequently obtains the actual power generation data from 00:00 to 24:00 on Jan. 2, 2024, as shown in curve 524.

The following embodiment takes the electrical load as an example. The power prediction device 100 uses the historical electrical load data within the past time interval from 00:00 to 24:00 on Jan 1, 2.024 to compute the predicted electrical load data from 00:00 to 24:00 on Jan.2, 2024. As shown in FIG. 5, the power prediction device 100 uses the historical electrical load data and obtains the predicted electrical load data, as shown in curve 514. Furthermore, the power prediction device 100 subsequently obtains the actual electrical load data from 00:00 to 24:00 on Jan. 2, 2024, as shown in curve 512.

As shown in FIG. 5, the power prediction application may respectively predict the power generation and electrical load within the corresponding time interval (e.g., the next day), and the difference between the prediction value and the actual value lies within a tolerance range.

Reference is made to FIG. 1. The processor 110 may be but is not limited to the microprocessor, the Digital Signal Processors (DSP), the Application Specific Integrated Circuit (ASIC), the central processing unit (CPU), the System on Chip (SoC), the Field Programmable Gate Array (FPGA), the network processor chip, or any combination of the elements above. Furthermore, the processor 110 may be a general term referring to one or more processors and the number of the processor is not limited herein.

The storage 120 may be but is not limited to the Random Access Memory (RAM), the Flash memory, the Read Only Memory (ROM), the Hard Disk Drive (HDD), the Solid State Drive (SSD), the optical storage, or any combination of the elements above.

In one embodiment, the power prediction method of microgrids may be implemented as computer program codes, stored in a non-transitory computer-readable storage medium (e.g., the processor 120). The computer or the computation device reads the computer program codes from the storage medium to perform the power prediction method of microgrids.

Accordingly, the disclosure provides the power prediction method and the power prediction device of microgrids with the microgrid cluster power-computing model: the stagnant condition is used to adaptively adjust the learning rate based on the training condition; the early stopping condition is used to eliminate unqualified model as early as possible; the optimizer is used to perform the weight regularization to maintain the gradients of each neural network layer at a suitable update rate, so over-updated or under-updated parameters are prevented and the issue such as gradient explosion and vanish gradients is effectively avoided. Therefore, the mechanism of the disclosure is suitable for power prediction of microgrid clusters, maintaining high prediction accuracy over long time sequences.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A power prediction method of microgrids, performed by a computation device, the power prediction method comprising:
inputting a time-series power data of the microgrids into a microgrid cluster power-computing model to compute a predicted time-power data;
computing a monitoring indicator of the microgrid cluster power-computing model based on the predicted time-power data;
adjusting a learning rate of the microgrid cluster power-computing model when determining a stagnant condition is met based on the monitoring indicator, and continuously inputting the time-series power data into the microgrid cluster power-computing model to obtain the monitoring indicator; and
obtaining a trained microgrid cluster power-computing model when the stagnant condition is not met and an execution count reaches a predefined epoch count, and using the trained microgrid cluster power-computing model to perform a power prediction of multiple microgrids over a future time interval.

2. The power prediction method of claim 1, wherein the monitoring indicator comprises a loss rate or an accuracy of the microgrid cluster power-computing model, and the power prediction method comprises:
determining that the stagnant condition is met when the loss rate does not continuously decrease or the accuracy does not continuously increase or plateau achieving a first quantity, wherein the first quantity is less than the predefined epoch count.

3. The power prediction method of claim 2, further comprising:
completing a training the microgrid cluster power-computing model in advance when determining that an early stopping condition is met based on the monitoring indicator.

4. The power prediction method of claim 3, further comprising:
determining that the early stopping condition is met when the loss rate does not continuously decrease or the accuracy does not continuously increase or plateau achieving a second quantity, wherein the second quantity is greater than the first quantity and less than the predefined epoch count.

5. The power prediction method of claim 1, wherein a step after inputting the time-series power data into the microgrid cluster power-computing model comprises:
inputting the time-series power data into a gated recurrent unit of the microgrid cluster power-computing model to compute multiple temporal state features;
inputting the multiple temporal state features into a first fully connected layer of the microgrid cluster power-computing model to obtain multiple first advanced temporal features;
inputting the multiple first advanced temporal features into a second fully connected layer of the microgrid cluster power-computing model to obtain multiple second advanced temporal features; and
inputting the multiple second advanced temporal features into a third fully connected layer of the microgrid cluster power-computing model to perform a regression computation on the multiple second advanced temporal features, and obtaining multiple key temporal features.

6. The power prediction method of claim 5, wherein a step after obtaining the multiple key temporal features comprises:
sending the multiple key temporal features to an activation function of the microgrid cluster power-computing model to compute the predicted time-power data.

7. The power prediction method of claim 5, wherein a node quantity of the first fully connected layer is greater than the node quantity of the second fully connected layer, and the node quantity of the second fully connected layer is greater than the node quantity of the third fully connected layer.

8. The power prediction method of claim 5, wherein the microgrid cluster power-computing model further comprises an optimizer, and the power prediction method further comprises:
adjusting a parameter update magnitude of each of the gated recurrent unit, the first fully connected layer, the second fully connected layer, and the third fully connected layer by the optimizer.

9. The power prediction method of claim 2, wherein a step after computing the predicted time-power data comprises:
computing a prediction error according to an error indicator; or
computing the accuracy according to the predicted time-power data and the time-series power data for computing the predicted time-power data.

10. The power prediction method of claim 1, wherein a step before inputting the time-series power data into the microgrid cluster power-computing model comprises:
respectively obtaining multiple historical time-power data of each of the multiple microgrids; and
combining the multiple historical time-power data from the multiple microgrids based on a time series to obtain the time-series power data.

11. A power prediction device of microgrids, comprising:
a storage, configured to store multiple program codes and a microgrid cluster power-computing model; and
a processor, connected to the storage and configured to execute the multiple program codes to perform operations of:
inputting a time-series power data of the microgrids into the microgrid cluster power-computing model to compute a predicted time-power data;
computing a monitoring indicator of the microgrid cluster power-computing model based on the predicted time-power data;
adjusting a learning rate of the microgrid cluster power-computing model when determining a stagnant condition is met based on the monitoring indicator, and continuously inputting the time-series power data into the microgrid cluster power-computing model to obtain the monitoring indicator; and
obtaining a trained microgrid cluster power-computing model when the stagnant condition is not met and an execution count reaches a predefined epoch count, and using the trained microgrid cluster power-computing model to perform a power prediction of multiple microgrids over a future time interval.

12. The power prediction device of claim 11, wherein the monitoring indicator comprises a loss rate or an accuracy of the microgrid cluster power-computing model, and the processor is configured to perform operations of:
determining that the stagnant condition is met when the loss rate does not continuously decrease or the accuracy does not continuously increase or plateau achieving a first quantity, wherein the first quantity is less than the predefined epoch count.

13. The power prediction device of claim 12, wherein the processor is further configured to perform operations of:
completing a training the microgrid cluster power-computing model in advance when determining that an early stopping condition is met based on the monitoring indicator.

14. The power prediction device of claim 13, wherein the processor is further configured to perform operations of:
determining that the early stopping condition is met when the loss rate does not continuously decrease or the accuracy does not continuously increase or plateau achieving a second quantity, wherein the second quantity is greater than the first quantity and less than the predefined epoch count.

15. The power prediction device of claim 11, wherein the processor is further configured to perform operations of:
inputting the time-series power data into a gated recurrent unit of the microgrid cluster power-computing model to compute multiple temporal state features;
inputting the multiple temporal state features into a first fully connected layer of the microgrid cluster power-computing model to obtain multiple first advanced temporal features;
inputting the multiple first advanced temporal features into a second fully connected layer of the microgrid cluster power-computing model to obtain multiple second advanced temporal features; and
inputting the multiple second advanced temporal features into a third fully connected layer of the microgrid cluster power-computing model to perform a regression computation on the multiple second advanced temporal features, and obtaining multiple key temporal features.

16. The power prediction device of claim 15, wherein the processor is further configured to perform operations of:
sending the multiple key temporal features to an activation function of the microgrid cluster power-computing model to compute the predicted time-power data.

17. The power prediction device of claim 15, wherein a node quantity of the first fully connected layer is greater than the node quantity of the second fully connected layer, and the node quantity of the second fully connected layer is greater than the node quantity of the third fully connected layer.

18. The power prediction device of claim 15, wherein the microgrid cluster power-computing model further comprises an optimizer, and the processor is further configured to perform operations of:
adjusting a parameter update magnitude of each of the gated recurrent unit, the first fully connected layer, the second fully connected layer, and the third fully connected layer by the optimizer.

19. The power prediction device of claim 12, wherein the processor is further configured to perform operations of:
after computing the predicted time-power data, executing the microgrid cluster power-computing model to compute a prediction error according to an error indicator or compute the accuracy according to the predicted time-power data and the time-series power data for computing the predicted time-power data.

20. The power prediction device of claim 11, wherein the processor is further configured to perform operations of:
before inputting the time-series power data into the microgrid cluster power-computing model, respectively obtaining multiple historical time-power data of each of the multiple microgrids; and
combining the multiple historical time-power data from the multiple microgrids based on a time series to obtain the time-series power data.
